(19) United States
(12) Patent Application Publication
(10) Pub. No.: US 2008/0222141 A1
(43) Pub. Date: Sep. 11, 2008

(54) Method and System for Document Searching

(75) Inventor: David A. Morales, El Paso, TX (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: ALTEP, INC., El Paso, TX (US)

(21) Appl. No.: 12/038,797

(22) Filed: Feb. 27, 2008

Related U.S. Application Data
(60) Provisional application No. 60/893,602, filed on Mar. 7, 2007.
(60) Provisional application No. 60/893,612, filed on Mar. 7, 2007.
(60) Provisional application No. 60/911,822, filed on Apr. 13, 2007.

(51) Int. Cl. G06F 17/30

(52) U.S. Cl. 707/5; 707/E17.014

(57) ABSTRACT

A method and system for comparing search results is described. In one embodiment, the method comprises receiving a search query; searching a plurality of documents using the search query to generate a first query result; storing the first query result; searching a plurality of documents using the search query to generate a second query result; comparing the first query result and the second query result to generate a compare result; and displaying the compare result. In other embodiments, the process includes a machine-readable medium that provides instructions for a processor, which when executed by the processor cause the processor to perform a method of the present invention.

### CROSS-REFERENCE TO RELATED APPLICATIONS

This application claims benefit and priority under 35 U.S.C. §119(e) of the following co-pending provisional applications having at least one common inventor with this application Ser. No. 60/893,602, filed Mar. 7, 2007, entitled “Method and System for Document Searching”; Ser. No. 60/893,612, filed Mar. 7, 2007, entitled “Method and System for Searching and Generating To Do List”; Ser. No. 60/911,822, filed Apr. 13, 2007, entitled “Method and System for Hierarchical Document Management in a Document Review System”. The entire disclosures of the above applications are incorporated herein by reference.

The entire disclosure of commonly-assigned co-pending application Ser. No. not yet assigned, attorney docket no. 101915-200101/US, entitled “Method and System for Rules Based Tag Management in a Document Review System,” by inventor Willem van de Berge, filed the same day as this application, is incorporated herein by reference.

The entire disclosure of commonly-assigned co-pending application Ser. No. not yet assigned, attorney docket no. 101915-200301/US, entitled “Method and System for Searching and Generating To Do List,” by inventor David A. Morales, filed the same day as this application, is incorporated herein by reference.

The entire disclosure of commonly-assigned co-pending application Ser. No. not yet assigned, attorney docket no. 101915-200401/US, entitled “Method and System for Universal File Types in a Document Review System,” by inventor Willem van den Berge, filed the same day as this application, is incorporated herein by reference.

The entire disclosure of commonly-assigned co-pending application Ser. No. not yet assigned, attorney docket no. 101915-200501/US, entitled “Method and System for Hierarchical Document Management in a Document Review System,” by inventor David A. Morales, filed the same day as this application, is incorporated herein by reference.

### TECHNICAL FIELD

This invention relates generally to the field of document review systems. More particularly, the invention relates to a method and system for searching documents.

### BACKGROUND

Document review systems are used for managing the document review in the discovery phase of litigation. Document review systems are employed to process search queries to identify documents with specific words or phrases within a set of documents and identify documents that meet specified criteria with common identifiers, such as tags. Some document review systems allow search queries to be saved for subsequent use. Some document review systems allow for search results to be saved. What is needed is a method to compare search results over time.

### BRIEF SUMMARY

A method and system for comparing search results is described. In one embodiment, the method comprises searching a plurality of documents using the search query to generate a first query result; storing the first query result; searching a plurality of documents using the search query to generate a second query result; comparing the first query result and the second query result to generate a compare result; and displaying the compare result. In other embodiments, the process includes a machine-readable medium that provides instructions for a processor, which when executed by the processor cause the processor to perform a method of the present invention.

### BRIEF DESCRIPTION OF THE DRAWINGS

These and other features, aspects, and advantages of the present invention will become better understood with regard to the following description, appended claims, and accompanying drawings where:

FIG. 1 illustrates a block diagram of one embodiment of a system of the invention.

FIG. 2 illustrates one embodiment of a flow diagram of a method of comparing two document search results.

FIG. 3 illustrates one embodiment of a representation of a representation of a screen image of a search query builder.

FIG. 4 illustrates another embodiment of a representation of a screen image of a search query builder.

FIG. 5 illustrates another embodiment of a representation of a screen image of a compared search result.

FIG. 6 shows a system having a machine-readable medium to store a set of instructions to perform a process according to one embodiment.

### DETAILED DESCRIPTION

At least some embodiments of the disclosure relate to a method and process for searching documents.

The following description and drawings are illustrative and are not to be construed as limiting. Numerous specific details are described to provide a thorough understanding of the disclosure. However, in certain instances, well known or conventional details are not described in order to avoid obscuring the description. References to one or an embodiment in the present disclosure can be, but not necessarily are, references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

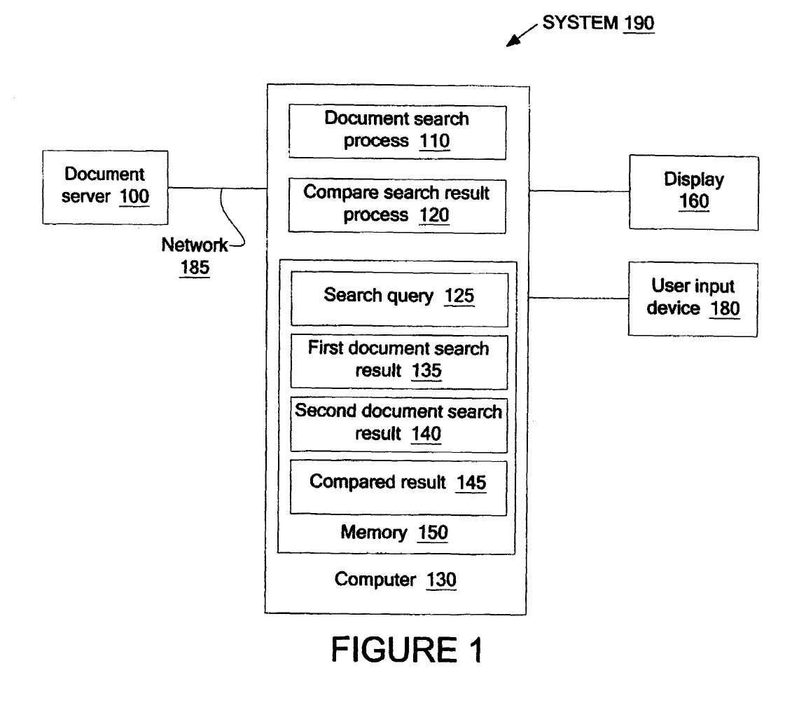

FIG. 1 illustrates one embodiment of a system 190 of the present invention. The system 190 includes a computer 130 coupled to a user-input device 180 and a display 160. The computer 130 has a document search process 110, a compare search result process 120 and a memory 150. The computer 130 is coupled through a network 185 to communicate with a document server 100. In one embodiment, the system 190 is used for document review during the discovery phase of litigation. In other embodiments, the system 190 is used in other document review applications.

In one embodiment, the computer 130 receives a request for a search query 125 through the user-input device 180. The search query 125 is stored in a memory 150. The search query 125 is limited in scope of documents to be searched by indicating, for example, which folders within a folder structure should be searched. The search query 125 includes a logical expression used to evaluate whether a document satisfies the search query 125.

The document search process 110 executes the search query 125 and searches the documents in the selected folders stored on the document server 100 to generate a first document search result 135. The first document search result 135 is stored in the memory 150.

At a subsequent time, the computer 130 receives a request to execute the search query 125 again. The document search process 110 accesses the search query 125 from the memory 150 and executes the search query 125 to generate a second document search result 140. The second document search result 140 is stored in the memory 150. The compare search results process 120 compares the first search result 135 and the second search results 140 to produce a compared result 145. The compared result 145 is stored in the memory 150. The computer 140 displays the compared result 145 on the display 160.

The user-input device 180 may be a keyboard, mouse, a voice recognition device, or some other device used to receive input from a user. In some embodiments, the user-input device 180 includes more than one means to receive user-input, such as keyboard and mouse. The display 160 may be a computer monitor or any other device used to present output of a computer.

In one embodiment, the compared result 145 is a list of documents that are in the second search result 140 but not the first search result 135. In another embodiment, the compared result 145 is a list of documents that are in the first search result 135 but not the second search result 140. In another embodiment, the compared result 145 includes all documents in either the first or second search result with an indicator as to which of the first and second search result the document is in.

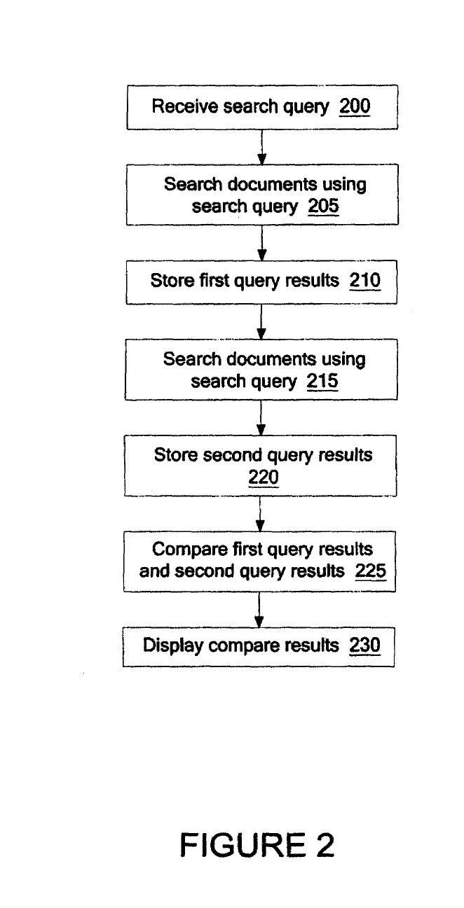

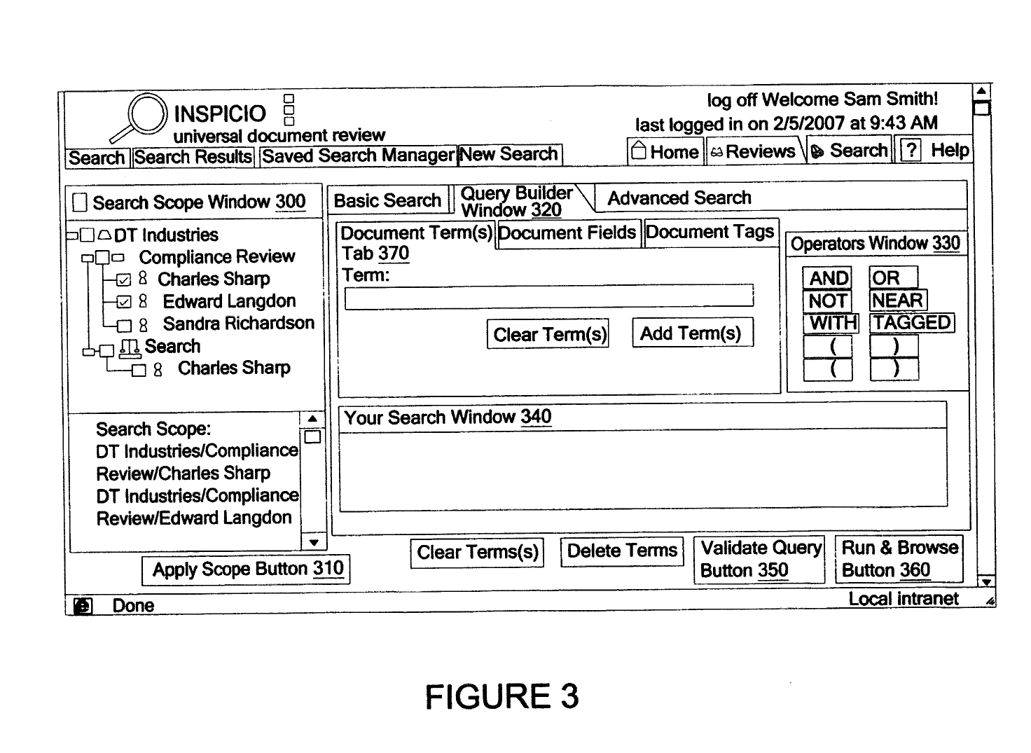

FIG. 2 is a flow diagram of a method of the present invention and is described in conjunction with FIG. 1 and FIGS. 3, 4 and 5 representing screen images in one embodiment of the invention. In process 200, a search query is received from user-input device 180.

FIG. 3 illustrates a representation of a screen image of a query builder when a Document Terms tab 370 is selected. A Search Scope window 300 allows the user to select folders and subfolders that store documents to be searched. An Apply Scope button 310 applies the specified scope to the search query. A Query Builder window 320 allows for document terms to be entered and an Operators window 330 includes buttons for logical operators to be added to the search query. A Your Search window 340 displays the search query. A Validate Query button 350 checks the search query to determine whether the search query is consistent with required search query syntax. A Run and Browse button 360 executes the search query with the specified scope to produce a search result. In one embodiment, the search query 125, the first search result 135 and the second search result 140 are stored in a memory 150.

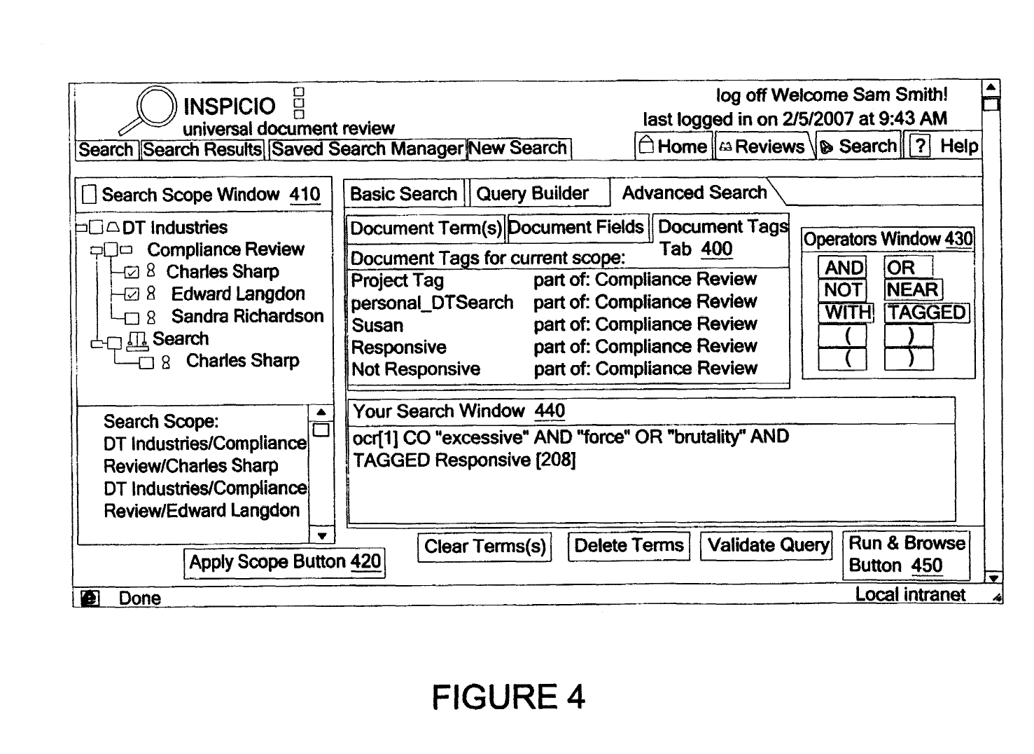

FIG. 4 illustrates a representation of a screen image of a query builder when a document tags tab 400 is selected. A Search Scope window 410 allows the user to select folders and subfolders that store documents to be searched. The Apply Scope button 420 applies the specified scope to the search query. A Document Tags tab 400 allows for document tags to be entered and an Operators window 430 includes buttons for logical operators to be added to the search query.

Tags are associated with particular documents to differentiate documents that meet some specific criteria from the documents that do not. For example, in the discovery process of litigation, a document reviewer might associate a “relevant” tag with a document to indicate that that document is relevant to an issue in the litigation. In some embodiments, the identifiers used to classify documents according to criteria are referred to by other names, such as markers, flags or folders.

A Your Search window 440 displays the search query. A Validate Query checks the search query to determine whether the search query is consistent with required search query syntax. A Run and Browse button 450 executes the search query with the specified scope to generate a search result. In one embodiment, the search query and the search result are stored in a memory.

In process 205, the document search process 110 uses the search query to search the documents within the selected scope on the document server 100. In one embodiment, the document server 100 is a local hard disk drive on the computer 130. In another embodiment, the document server is a remote server accessed over the internet.

In process 210, the first document search result 135 is stored in the memory 150.

In process 215, the document search process 110 uses the search query 125 to search the documents within the selected scope on the document server 100. In one embodiment, the search query 125 is saved in the memory 150. In one embodiment, the user selects a saved search query from a list to execute that search query after the first time the search query is executed.

In process 220, the second document search result 140 is stored in the memory 150. In one embodiment, the second document search result 140 is not stored, but rather portions of the second document search result 140 are discarded after those portions are compared against the first document search result 135.

In process 225, the compare search result process 120 compares the first search result 135 and the second search result 140 to generate a compared result 145.

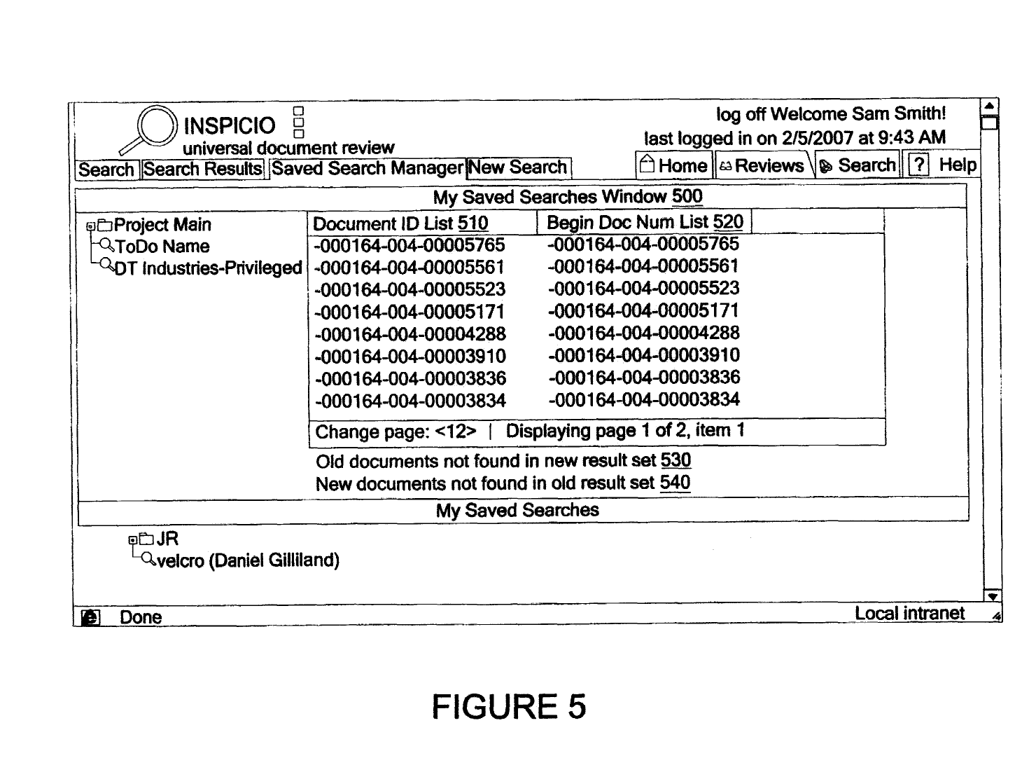

FIG. 5 illustrates a representation of a screen image for comparing two search results for execution by the document search process 110. In the My Saved Searches window 500 there is a folder structure in which search results are organized. A document ID list 510 and document numbers list 520 are displayed. In one embodiment, the text lines “Old documents not found in new result set” 530 and “New documents not found in old result set” 540 are displayed indifferent colors and used as a color key for the list of document IDs and document numbers.

In process 250, it is determined whether another document is requested. If yes, process 200 is performed. Otherwise the process is completed.

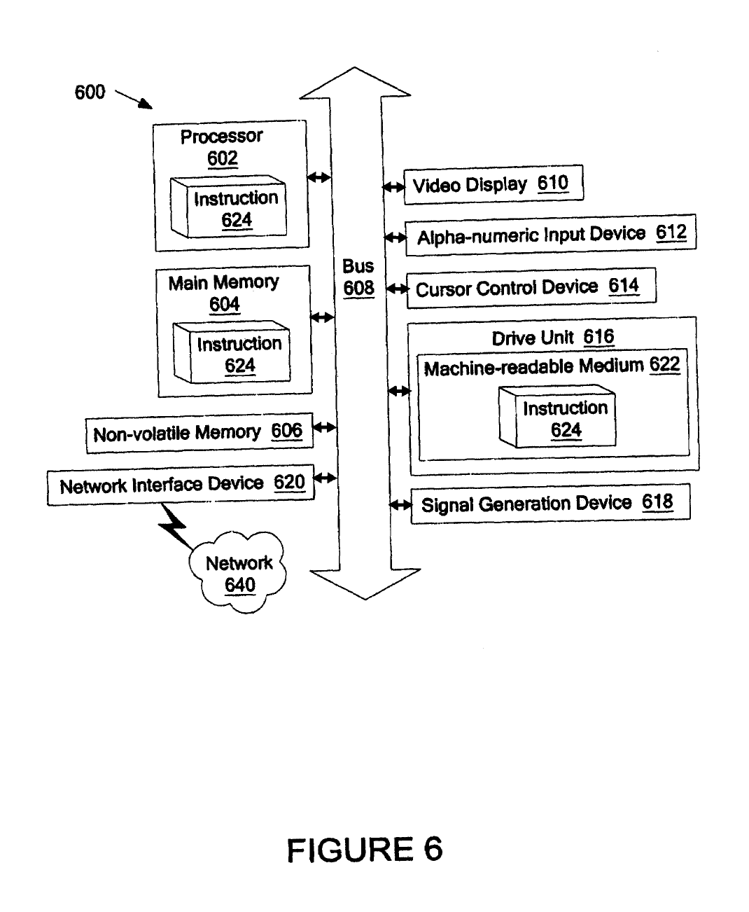

FIG. 6 shows a diagrammatic representation of a machine in the exemplary form of a computer system 600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In one embodiment, the machine communicates with the server to facilitate operations of the server and/or to access the operations of the server.

The computer system 600 includes a processor 602 (e.g., a central processing unit (CPU) a graphics processing unit (GPU) or both), a main memory 604 and a nonvolatile memory 606, which communicate with each other via a bus 608. In some embodiments, the computer system 600 may be a laptop computer, personal digital assistant (PDA) or mobile phone, for example. The computer system 600 may further include a video display unit 610 (e.g., a liquid crystal display (LCD) or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620. The disk drive unit 616 includes a machine-readable medium 622 on which is stored one or more sets of instructions (e.g., software 624) embodying any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media. The software 624 may further be transmitted or received over a network 640 via the network interface device. 620.

While the machine-readable medium 622 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

In general, the routines executed to implement the embodiments of the disclosure, may be implemented as part of an operating system or a specific application, component, program, object, module or sequence of instructions, referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although embodiments have been described with reference to specific exemplary embodiments, it will be evident that the various modification and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method for performing document review comprising:
receiving a search query;
searching a plurality of documents using the search query to generate a first document search result;
storing the first query result;
searching a plurality of documents using the search query to generate a second document search result;
comparing the first document search result and the second document search result to generate a compare result; and
displaying the compare result.

2. The method of claim 1 wherein the search query comprises a logical expression depending on a tag.

3. The method of claim 1 wherein the search query comprises a logical expression depending on a field.

4. The method of claim 1 wherein the search query comprises a logical expression depending on a field and a tag.

5. The method of claim 1 wherein the compare result comprises documents in the second document search result but not the first document search result.

6. The method of claim 1 wherein the compare result comprises documents in the first document search result but not the second document search result.

7. The method of claim 1 wherein the compare result comprises documents in the first document search result and the second document search result.

8. The method of claim 1 wherein the compare result comprises an indicator corresponding to each document indicating whether the document is in the first document search result, the second document search result or both the first and second document search results.

9. A machine-readable medium that provides instructions for a processor, which when executed by the processor cause the processor to perform a method comprising:
receiving a search query;
searching a plurality of documents using the search query to generate a first query result;
storing the first document search result;
searching a plurality of documents using the search query to generate a second document search result;
comparing the first document search result and the second document search result to generate a compare result; and
displaying the compare result.

10. The machine-readable medium of claim 9 wherein the search query comprises a logical expression depending on a tag.

11. The machine-readable medium of claim 9 wherein the search query comprises a logical expression depending on a field.

12. The machine-readable medium of claim 9 wherein the search query comprises a logical expression depending on a field and a tag.

13. The machine-readable medium of claim 9 wherein the compare result comprises documents in the second document search result: but not the first document search result.

14. The machine-readable medium of claim 9 wherein the compare result comprises documents in the first document search result but not the second document search result.

15. The machine-readable medium of claim 9 wherein the compare result comprises documents in the first document search result and the second document search result.

16. The machine-readable medium of claim 9 wherein the compare result comprises an indicator corresponding to each document indicating whether the document is in the first document search result, the second document search result or both the first and second document search results.

17. A system comprising:
a memory configured to store a first search result;
a document search process configured to receive a search query, perform the search query to generate the first search result and a second search result, the first and second search results being the results of the search query performed at different times; and
a compare search process to compare the first search results and the second search results to generate a compared result.

18. The system of claim 17 wherein the search query comprises a logical expression depending on a tag.

19. The system of claim 17 wherein the search query comprises a logical expression depending on a field.

20. The system of claim 17 wherein the search query comprises a logical expression depending on a field and a tag.

21. The system of claim 17 wherein the memory is configured to store the second search result.

22. The system of claim 17 wherein the memory is configured to store the search query.
